(19) United States
(12) Patent Application Publication
(10) Pub. No.: US 2026/0130749 A1
(43) Pub. Date: May 14, 2026

(54) IMPLANT OSSEUX EXPANSIBLE, SYSTÈME ORTHOPÉDIQUE ET PROCÉDÉ DE FABRICATION DE L'IMPLANT

(71) Applicant: IN LIFE VET SA, Bulle (CH)

(72) Inventor: Guillaume LACAZE, La Rippe (CH)

(73) Assignee: IN LIFE VET SA, Bulle (CH)

(21) Appl. No.: 19/340,550

(22) Filed: Sep. 25, 2025

(30) Foreign Application Priority Data
Sep. 25, 2024 (EP) 24202391.9

(51) Int. Cl. A61D 1/00

(52) U.S. Cl. CPC A61D 1/00

(57) ABSTRACT

An expandable bone implant includes a casing enclosing the implant from proximal to distal ends. The casing is formed by a sheet of biocompatible metal alloy and fluidtightly closed on itself. The sheet has a plurality of pairs of folds, each of the pairs comprising a convex and concave fold. The surfaces between the convex and concave folds are rolled around the longitudinal axis. The proximal end is extended by a fluidtight sleeve on the lying-down and rolled folds of the sheet over the proximal end periphery. The distal end is extended by a socket fluidtightly on the lying-down and rolled folds over the distal end periphery. The sheet is plastically deformable to allow the expansion of the implant from the folded configuration to the deployed configuration, forming a fluidtight casing enclosing the implant and enabling avoidance of leakage when fluid is being injected into the implant and the casing.

The present application relates to the field of surgery, in particular veterinary orthopaedic surgery and in particular to the treatment of a folded bone structure by restoring the volume of (or correcting) this bone structure. The present application relates in particular to an implant and to the method for manufacturing it, as well as to a system for restoring bone structure, in particular in the spine for the treatment (often called “reduction”) of compression fractures, in particular vertebral compression fractures (VCFs).

In this field, the problem of restoring the volume of bone structure that has collapsed is well known and the literature contains an abundance of solutions using expandable implants capable of passing from a folded configuration to an expanded deployed configuration to restore the height of the bone structure, preferably in combination with an injection of bone substitute cement, known as cement (or bone cement). Many cements are known and they all have the advantage of being injectable in a liquid or viscous state for a certain period of time, then of hardening (by polymerization) inside the bone structure in order to stabilize it.

A major problem in this field concerns the expansion of the implant to restore height to the damaged bone tissue. Numerous solutions are known from the prior art, such as in particular from patent applications EP3086729, U.S. Pat. No. 11,540,926, EP3747385, EP2572680, EP3958752, EP2693967, EP2405835, U.S. Pat. No. 9,579,130, EP4216836, WO2023122005, WO2022162418, EP3843668 or U.S. Pat. No. 10,945,861 but these solutions present various problems of difficulty of handling for deploying to the expanded state, and of stability and reliability once deployed. Moreover, these known solutions are generally accompanied by an injection of bone cement, but do not provide any teaching relating to cement leakage outside of the implant, whereas such leakage can be detrimental to the surrounding tissue, or even to the entire organism if the chemical substances in the cement get into the bloodstream. In fact, cement generally comprises one or more polymerizable chemical substances, for example such as poly(methyl methacrylate) (PMMA) and possibly additives. In addition, the temperature reached during the polymerization of the cement is not harmless since it is generally greater than 60°.

Devices for the correction and stabilization (or bone fracture reduction), particularly of the spine in the form of a stent, or in the form of porous inflatable bags or of balloons, as in documents EP1408888 or EP1379185, possibly equipped with support flanges as in document US20060100706, are known from the prior art, in particular from documents EP1308134, U.S. Pat. Nos. 9,510,877, 8,936,627 or EP2467099. Numerous documents propose this type of stent, that is to say a deformable endoprosthesis similar to vascular stents, extenders or endoprostheses, which are generally in the form of a meshed tubular body, usually metallic and deformable by the introduction of an inflatable balloon to expand the body by spreading the meshes apart, the balloon then being removed to allow the injection of cement, which hardens and thus forms a correcting and stabilizing structure. However, these devices have the drawback of requiring implantation in two stages: the inflation of the balloon and then the injection of cement, which slows down and complicates the operation and also presents a risk of the device collapsing between the deflation of the balloon and filling of the stent with cement. Furthermore, these solutions have the drawback of not addressing the major problem of cement leaks.

Solutions using implants with a mesh structure, made of shape-memory metal, which is constrained into a folded shape for insertion into the bone tissue and capable of expanding spontaneously, when the stress is released and/or under heat, are also known, in particular from documents EP1938765, EP2351539 or WO200434924. These solutions have the drawback of using expensive alloys and complex manufacturing to obtain an adequate shape memory suitable for the intended implantation, which means additional cost when multiplied by the number of different implants necessary to cover the various pathological cases, in particular by the amplitude of the deformation of which the shape memory material is capable. Moreover, the force exerted by the return of the metal to its unstressed form is often not sufficient to properly correct the bone structure which has folded, or is at least a limiting factor. Furthermore, these solutions also have the drawback of not addressing the major problem of cement leaks.

Solutions using expandable implants that can be expanded using a lever mechanism, in the manner of a car jack, to restore the bone structure to a determined height are also known from the prior art, in particular from documents EP2405835, U.S. Pat. No. 9,579,130, EP2572680 or EP1956990. These solutions have the advantage of not risking collapse unlike a stent that is deployed by a balloon which is removed before the injection of the cement, but also have the drawback of implantation in two stages and of the fact that the dimensions of the support surface for exerting the expansion force on the bone tissue are limited, in comparison with stents in particular. Furthermore, they also have the drawback of being expensive and of likewise not addressing the major problem of cement leaks.

The problem of cement leakage has already been identified, in particular in documents EP1408888, EP1509175 or WO200394805, which express the advantages that would be offered by a deformable implant that is not very permeable or that is impermeable, so as to limit or prevent cement leakage. These documents envisage numerous solutions for an expandable implant, made of metal or polymer, which could be either soft and flexible such as a membrane or a fabric, or even elastic, or semi-rigid (“conformable”) or rigid, or made of a shape memory material, with a continuous or fenestrated wall (i.e., mesh) and which could be porous or non-porous. However, all these hypotheses described in these documents define, above all, conceivable treatment methods and objectives to be achieved, without providing any real teaching as regards the technical characteristics or the structural arrangement of the implants, or on how to obtain such implants and thus implement these methods. These proposals therefore present a major problem of technical feasibility.

Furthermore, one problem which is not identified in the prior art concerns the cement injection site and the distribution of the forces exerted on the bone tissues to rectify them. Indeed, the impermeability of an implant makes it possible to avoid cement leaks, but the nature of the impermeable membrane and its technical characteristics such as its physico-chemical and mechanical properties influence its ability to deploy without breaking and to rectify the bone structure. Thus, an elastic membrane has the drawback of deforming excessively in low density zones and thus of having a limited capacity to restore height, with, in addition, the risk of breaking at the points at which its maximum elasticity is exceeded because of this uncontrolled deformation. A semi-rigid membrane is therefore preferable, but this problem of deformation also involves a problem of shapes of the implant, in the folded configuration and especially in the deployed configuration. Indeed, the shape of the deployed implant delimits the cement injection site and the control of this site is important for the distribution of the forces leading to the filling of the low density zones while rectifying the structure (especially in terms of height), and this has an impact on the success of the operation. Thus, it will be understood that the provision of an implant that addresses all of these problems is accompanied by a problem regarding technical feasibility and therefore manufacture.

Other recurring problems in orthopaedic surgery include invasiveness (i.e., the goal of making the smallest possible incision and of minimizing lesions) and also the deployment ratio in order to obtain a deployed implant that fills the largest possible volume while having been introduced through the smallest possible passage. Furthermore, this deployment ratio will have an impact on the distribution of forces for rectifying the vertebrae: if the deformability is too great, the cement-injection pressure will deform the pouch rather than restoring height.

A problem complementary to that of deployment concerns folding, which is generally not possible in implants of the prior art. Control of the folding allows control over the deployment and therefore over the injection site with a uniform distribution of the cement and of the pressure to fill the space to be filled following the collapse. Perfect proportionality suited to the fracture while at the same time respecting the shape of the bone inside the fracture is thus achieved.

In this context, it will be understood that there is still in this field a technical problem concerning the restoration of bone structure (rectification or reduction of fracture or increase in volume after collapse) by means of an expandable (deployable) implant that is able to expand folded bone tissue and is impermeable enough to prevent or limit the leakage of cement out of the implant with control of the injection site.

Finally, a main problem that still persists in the field concerns the technical feasibility of manufacturing implants proposed in the prior art. Document WO200394805, for example, describes numerous methods of administering substances and in particular bone cement, with numerous variants envisaged for an expandable implant, made of metal or polymer, which could be either soft and flexible such as a membrane or a fabric, or semi-conformable or rigid, or made of a shape memory material, with a continuous or fenestrated (i.e., meshed) wall and which could be porous or non-porous. However, that document describes only conceivable methods of treatment, but does not provide any teaching as to the technical features, or the structural arrangement of these many hypothetical implants used for these envisaged methods, or on how to obtain such implants and thus actually implement these methods. These proposals therefore present a major problem of technical feasibility and define objectives to be achieved rather than means for achieving them. Moreover, although many objectives have been detailed in the literature, many implants proposed for achieving these objectives have never seen the light of day due to problems of manufacture. In order to address the problem of manufacture, it is necessary to take into account the problems related to the desire to compact/fold a “bag” (balloon/pouch) made of a rigid and impermeable material in order to:
pass through a cylindrical duct;
allow the pouch to expand without rupturing, despite the rigidity and the desired difference in volume between the folded volume and the deployed volume;
control the volume and the distribution of expansion forces on the bone.

In this context, one object of the present invention is to overcome at least certain drawbacks of the prior art by proposing an implant for restoring a folded bone structure that is reliable and simple to handle and to implant.

Expandable bone implant for veterinary orthopaedic surgery for restoring the volume and/or geometry of a bone, by expansion between a folded configuration and a deployed configuration, said implant extending along a longitudinal axis between a proximal end connectable with an implantation instrument for holding the implant and a distal end intended to be inserted first into the bone, at least two faces, for example an upper and a lower face, of the implant each comprising a flange for contact with bone tissue, each of the flanges comprising a central portion connected, by means of at least one hinge, to at least one pair of support arms each oriented in opposite directions within each pair, one arm of each pair being connected by a hinge to the distal end while the other arm is connected by a hinge to the proximal end, the implant being able to receive or comprising a central shaft extending through a sliding sleeve at the proximal end as far as a traction ring or socket at the distal end where it is able to transmit traction, when actuated by an instrument, to the distal end in order to allow it to move closer to the proximal end, causing the support arms to pivot, thus causing the flanges to move away from one another and, consequently, the expansion of the implant between the folded configuration and the deployed configuration,
characterized in that it comprises a casing enclosing said implant from the proximal end to the distal end and in that:
   said casing is formed by a sheet made of a biocompatible metal alloy and fluidtightly closed on itself;
   said sheet has, at least in the folded configuration, a plurality of pairs of folds, each of the pairs comprising an antiform fold, referred to as convex, and a synform fold, referred to as concave, said folds lying one on top of another in the folded configuration such that the surfaces present between each of said convex and concave folds are rolled around the longitudinal axis;
   said proximal end is extended by a fluidtight sleeve fluidtightly secured to the lying-down and rolled folds of said sheet over the entire periphery of the proximal end;
   said distal end is extended by a socket fluidtightly secured to the lying-down and rolled folds of said sheet over the entire periphery of the distal end of said implant;
   said sheet is plastically deformable to allow the expansion of the implant from the folded configuration to the deployed configuration, forming a fluidtight casing enclosing the implant and making it possible to avoid any leakage when a fluid is being injected into the implant and the casing.

According to another feature, the distance between a synform fold and the next antiform fold is longer than the distance between an antiform fold and the next synform fold to make it easier to roll the folds around the longitudinal axis of the implant in the folded configuration.

According to another feature, said sealing sleeve extends said proximal end, parallel to the longitudinal axis, to a distance that is greater than or equal to that to which the flanges extend from the centre of the implant.

According to another feature, said sealing sleeve has a through-opening of which the diameter is greater than or equal to that of the opening of the sliding sleeve, so that these two sleeves, the sealing sleeve and the sliding sleeve, form an entrance to the inside of the hollow body of the implant from a conduit of an implantation instrument holding the implant at the proximal end, able to convey a fluid that is to be injected into said implant.

According to another feature, the deployed position, it comprises a middle portion between its two ends that has the shape of a generalized cylinder of a length greater than or equal to that of the flanges, with possible and partial persistence of said folds, said middle portion being extended, at the end corresponding to the proximal end, by a frustoconical portion connecting the middle portion to the sleeve and, at the end corresponding to the distal end, by a frustoconical portion connecting the middle portion to the socket, the frustoconical portions having a permanent persistence of at least part of the lying-down and rolled folds near the proximal end and distal end.

According to another feature, said sheet is plastically deformable also from the folded configuration to the deployed position, in particular as a result of the persistence of the lying-down and rolled folds at the proximal and distal ends, enhancing the reversibility of the expansion.

According to another feature, said central shaft is able to collaborate with and/or is extended beyond the distal end of an implantation instrument at the proximal end of the implant and having an interior conduit in communication with a conduit formed in said central shaft and opening onto the space formed by the parting of the flanges, via at least one opening allowing said fluid to be injected into the implant.

According to another feature, said sheet is secured to the proximal end by a weld that fixes the proximal end of the lying-down and rolled folds against the exterior wall of said sliding sleeve and/or secured to the distal end by a weld that fixes the distal end of the lying-down and rolled folds against the exterior wall of said traction socket.

According to another feature, said sheet is compressed around the sleeve of the proximal end and/or around the socket of the distal end by a compression ring that holds the lying-down and rolled folds against the exterior wall of said sleeve and/or of said socket.

According to another feature, that the folds are, at least in the folded configuration, parallel to the longitudinal axis.

According to another feature, the sheet also comprises at least one pair of folds (a synform fold and an antiform fold) of axis not parallel to the longitudinal axis, preferably perpendicular so that the implant can expand also lengthwise, or oblique so that the implant can expand in a curved manner.

According to another feature, that the number of pairs of folds is comprised between 3 and 16, generally 4 to 12, and preferably of the order of 8.

According to another feature, the sheet has a thickness comprised between 3 and 100 microns, generally between 6 and 50, and preferably 10 and 30 microns.

According to another feature, the sheet is made of titanium alloy.

According to another feature, the distance between the folds is variable for one lateral face of the implant to the other, so that the shape of the implant in the deployed configuration is curved and/or asymmetric transversely to the longitudinal axis.

Another purpose of the present application is to overcome at least some of the disadvantages of the prior art by proposing a surgical intervention system that is easy to use and allows effective stabilization of bone tissue.

This purpose is achieved by a system for orthopaedic treatment of damaged bone tissue, comprising a bone substitute cement and at least one instrument for implantation and for injection of cement into the implant,

According to another feature, the instrument for implantation and for injection of cement comprises means for controlling the pressure and/or the aspiration of the cement so that the implant can be re-folded to the folded configuration if necessary.

According to another feature, that the implantation instrument is distinct from but complements the injection instrument the cement-injection canal of which passes through a canal inside the rod of the implantation instrument that via its distal end holds the proximal end of the implant.

Another purpose of this application is to overcome at least some of the disadvantages of the prior art by proposing a method for obtaining an implant according to the present invention.

This objective is achieved by a method of manufacturing an implant according to one of the preceding claims, characterized in that it comprises:
Obtaining an expandable implant with two flanges that can be parted under the effect of the ends of the implant being moved closer together by support arms that connect these ends to the flanges;
Closing the sheet onto itself and welding it to form a generalized cylinder;
Inserting the closed sheet onto a matrix in the shape of a generalized cylinder having a star-shaped base, known as a star-shaped rod, the number of branches of the star defining the number of pairs of folds of said sheet of said implant;
Compression of the closed sheet between said mold and a plurality of protruding elements complementary in shape to the hollows between the branches of the star;
Winding of the folds of said sheet around the longitudinal axis;
Insertion of said expandable implant inside said compressed sheet;
   Securing said sheet to the sleeve and the casing;

Other features and advantages of the present invention will become more clearly apparent on reading the following description of various embodiments, with reference to the appended drawings, in which:

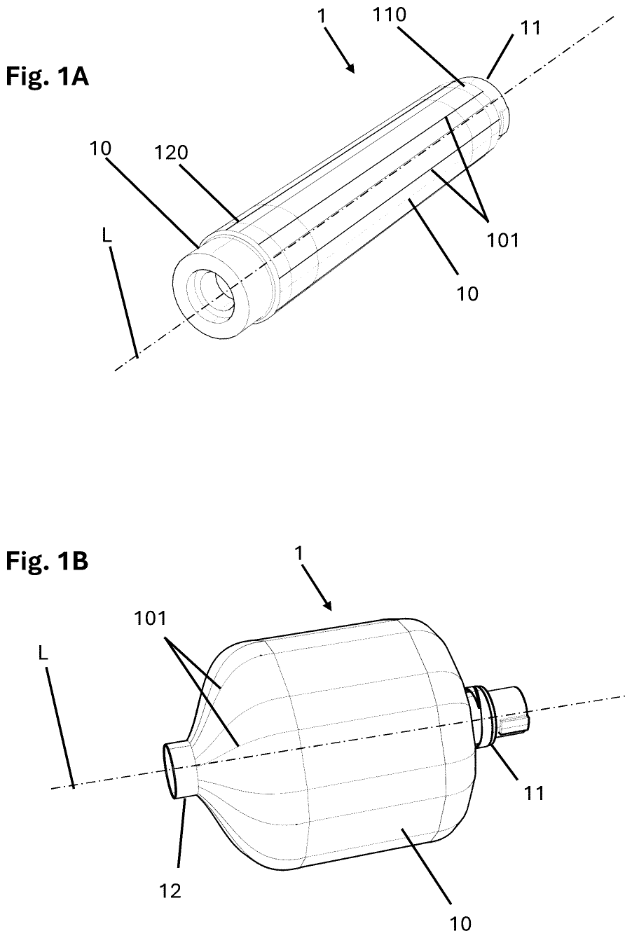

FIG. 1A depicts a perspective view of an implant in its folded configuration, according to certain embodiments, and FIG. 1B depicts a perspective view of the same implant in its deployed configuration;

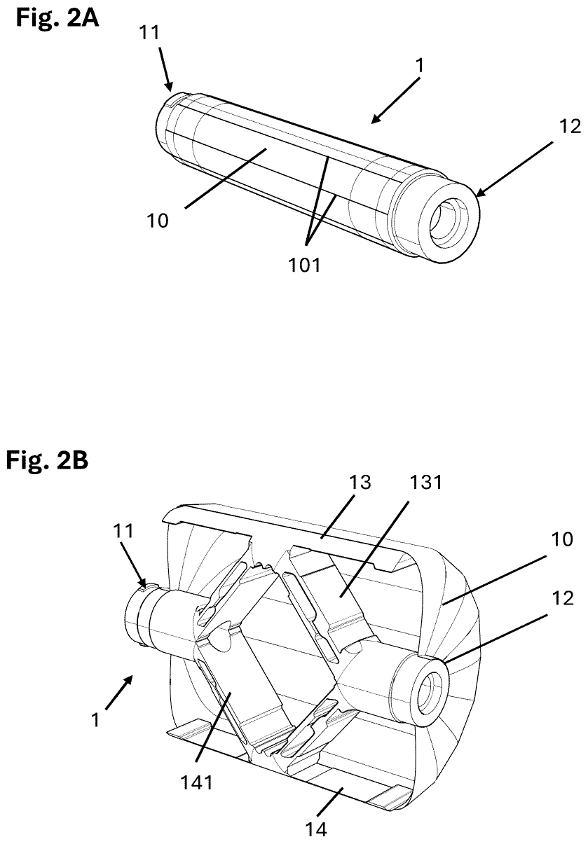

FIG. 2A depicts a perspective view of an implant without a casing and with fewer folds than the implant in FIG. 1A and FIG. 2B depicts a perspective view of this same implant from FIG. 2A in a deployed configuration with half of its casing removed to make the inside visible;

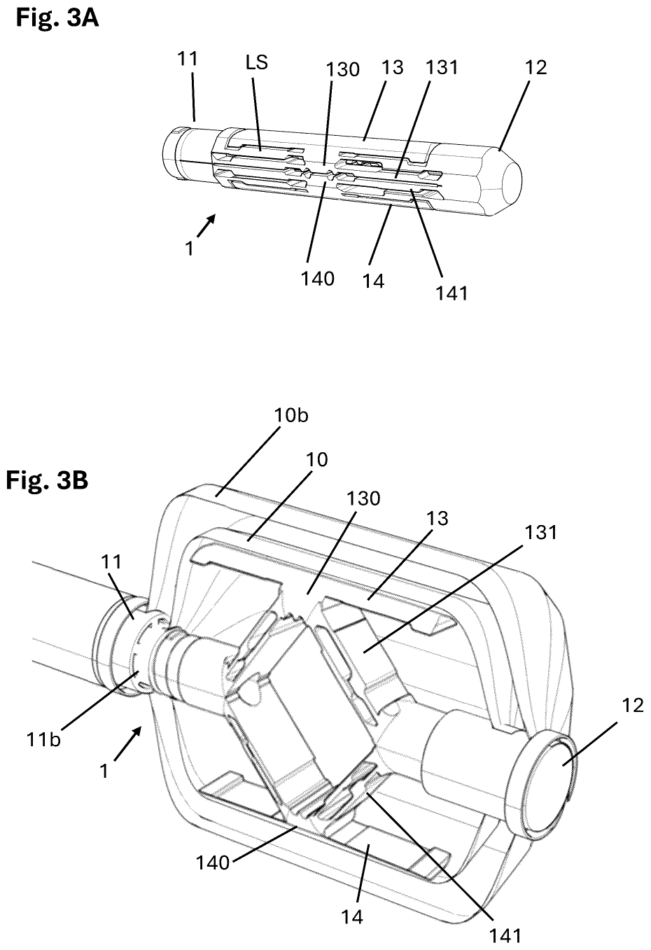

FIG. 3A depicts a perspective view of an expandable implant without its casing according to certain embodiments in its folded configuration and FIG. 3B depicts a perspective view of a double-casing implant in the deployed configuration according to certain embodiments;

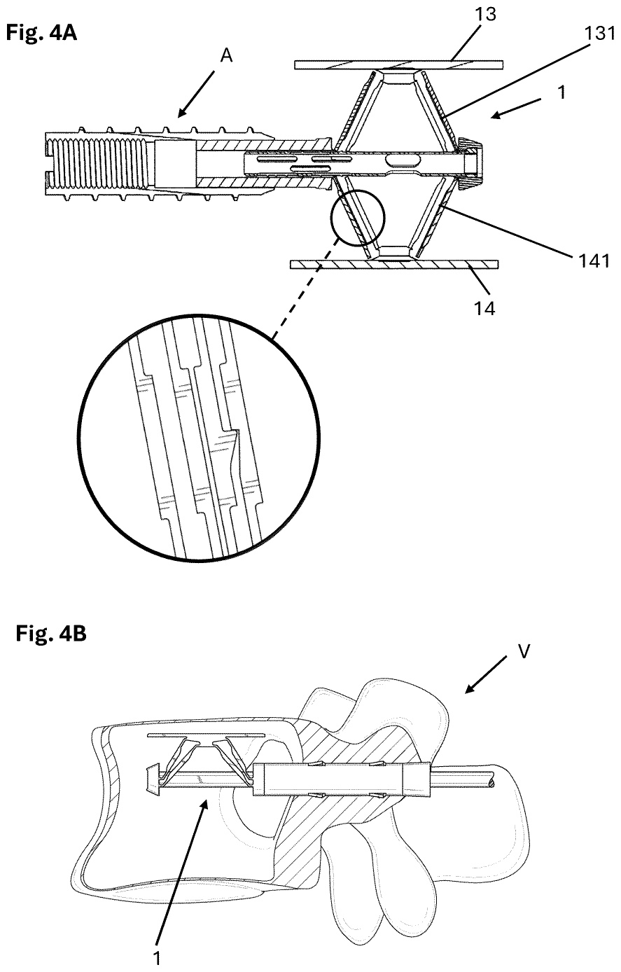

FIG. 4A depicts a cross-sectional view of an expandable implant carried by an implantation instrument and with an enlargement showing details of the support arms of such an implant with a self-locking mechanism, FIG. 4B depicts a cross-sectional view of a vertebra in which an expandable implant according to other embodiments is implanted;

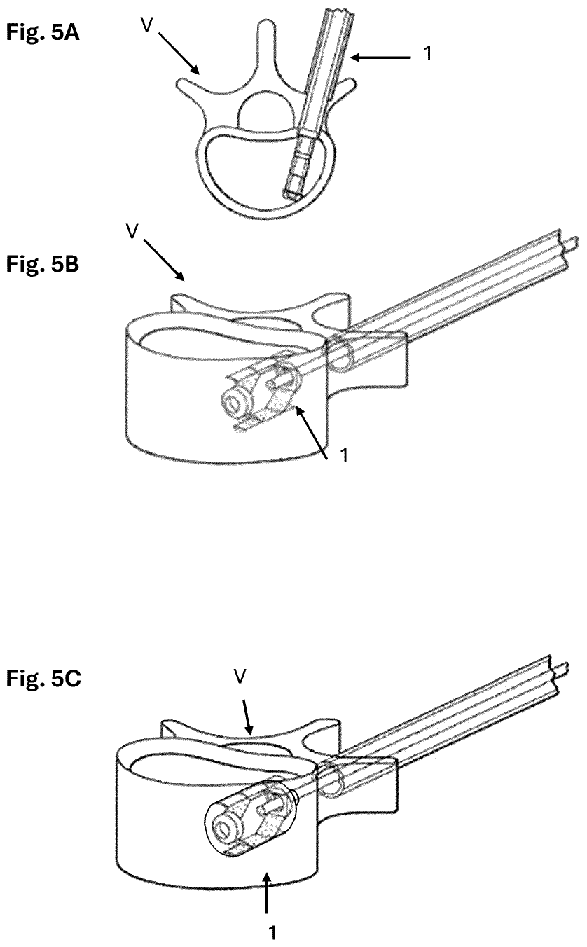

FIG. 5A depicts a view from above of a vertebra in which an implant according to various embodiments is implanted, FIG. 5B depicts a perspective view of a vertebra in which an implant of the prior art is implanted, and FIG. 5C depicts a perspective view of a vertebra in which an implant according to certain embodiments is implanted;

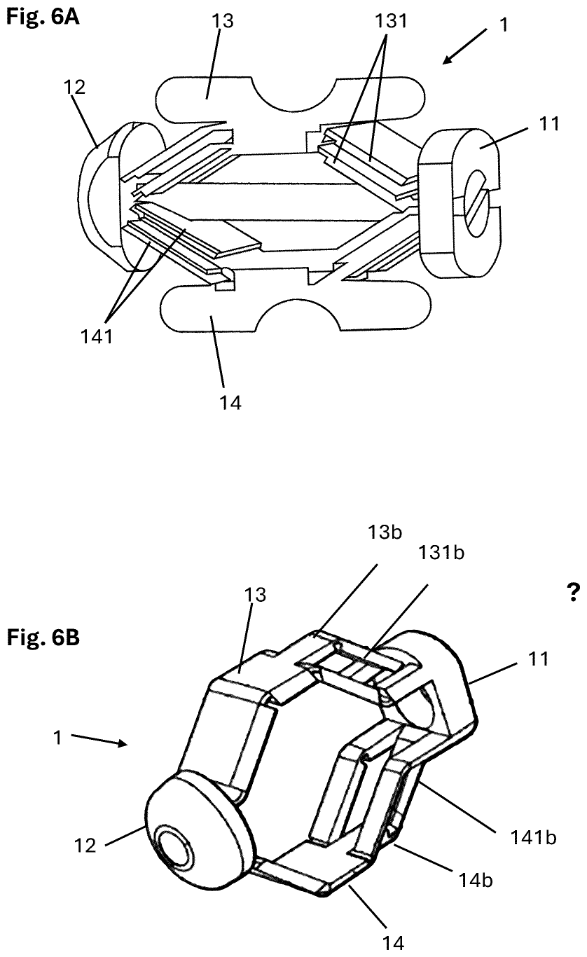

FIG. 6A depicts a perspective view of an implant according to certain embodiments and

FIG. 6B depicts a perspective view of an implant according to other embodiments;

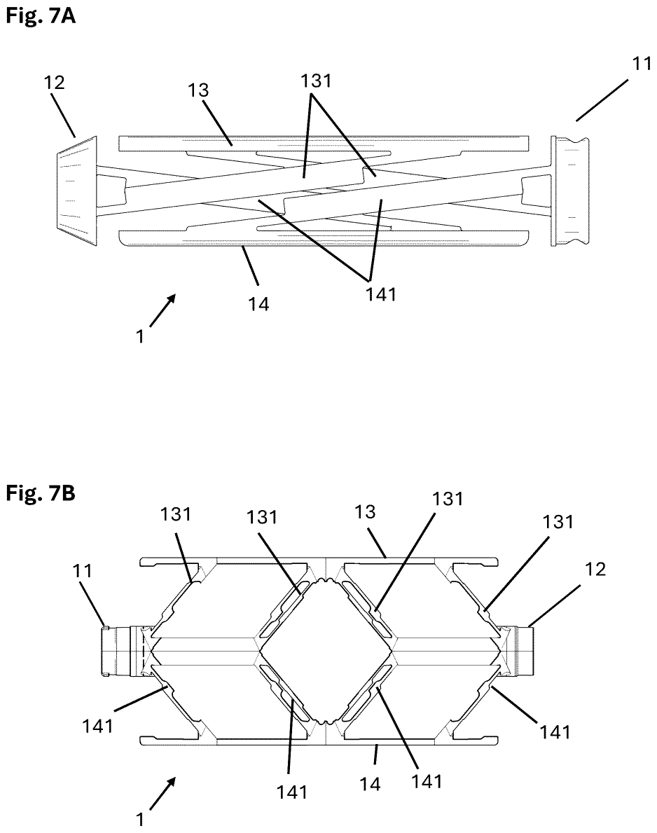

FIG. 7A depicts a profile view of an expandable implant according to certain embodiments and FIG. 7B depicts a profile view of the overlapping of the sheet at its closure;

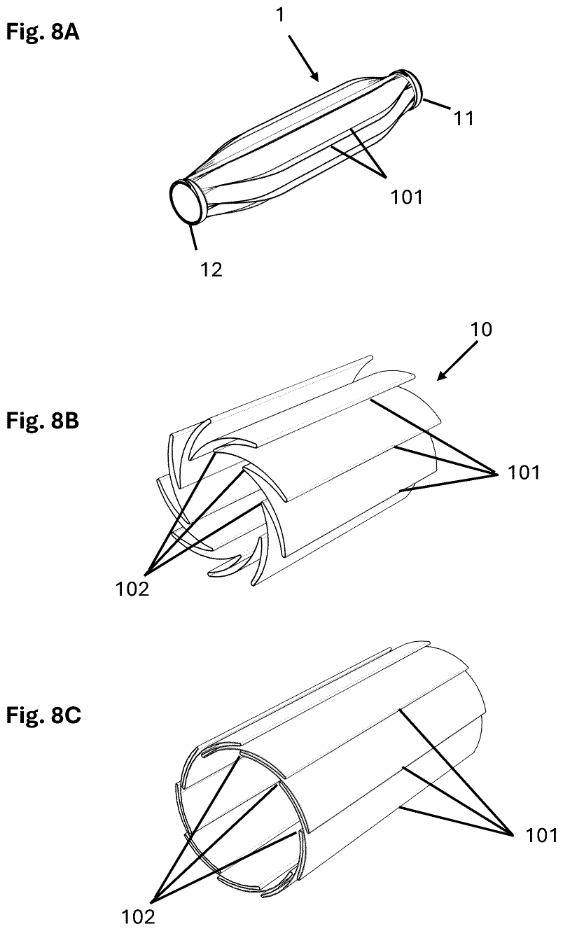

FIG. 8A depicts a perspective view of an expandable implant in a semi-deployed configuration, according to certain embodiments, FIG. 8B depicts a perspective view of a sheet used for the manufacture of an expandable implant according to certain embodiments in the semi-folded configuration, and FIG. 8C depicts a perspective view of this same sheet in the folded configuration;

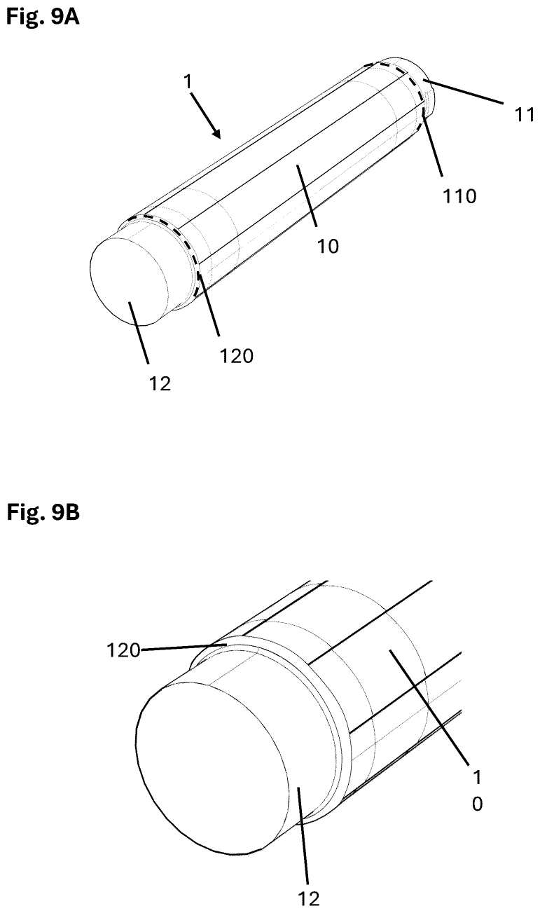

FIG. 9A depicts a perspective view of an expandable implant in the folded configuration with weld lines at the proximal and distal ends and FIG. 9B depicts an enlargement of FIG. 9A at the distal end;

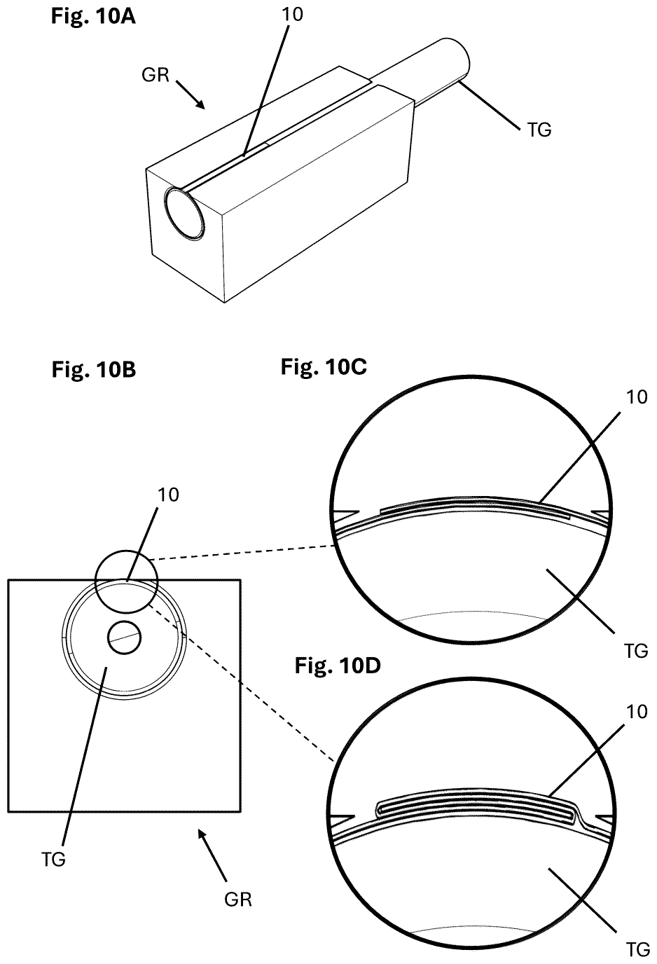

FIGS. 10: FIG. 10A depicts a perspective view of a guide tool that guides the folding of a sheet of an expandable implant according to certain embodiments guided by means of a guide tube and FIG. 10B shows a side view of the same tool with the sheet folded, with enlargements 10C and 10D showing side views of the sheet overlap at its closure according to two different examples of implementation;

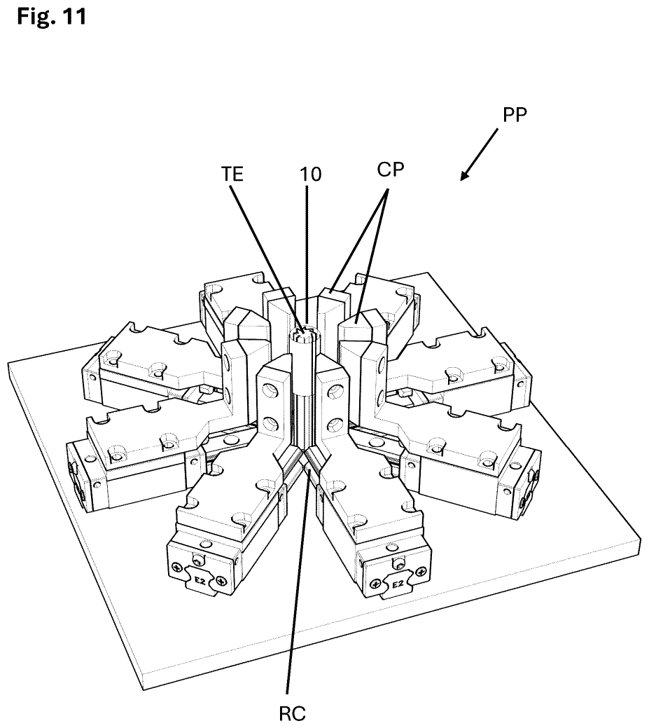

FIG. 11 depicts a perspective view of a tool for the pre-folding of sheets for a design according to the various embodiments, using a pre-folding plate;

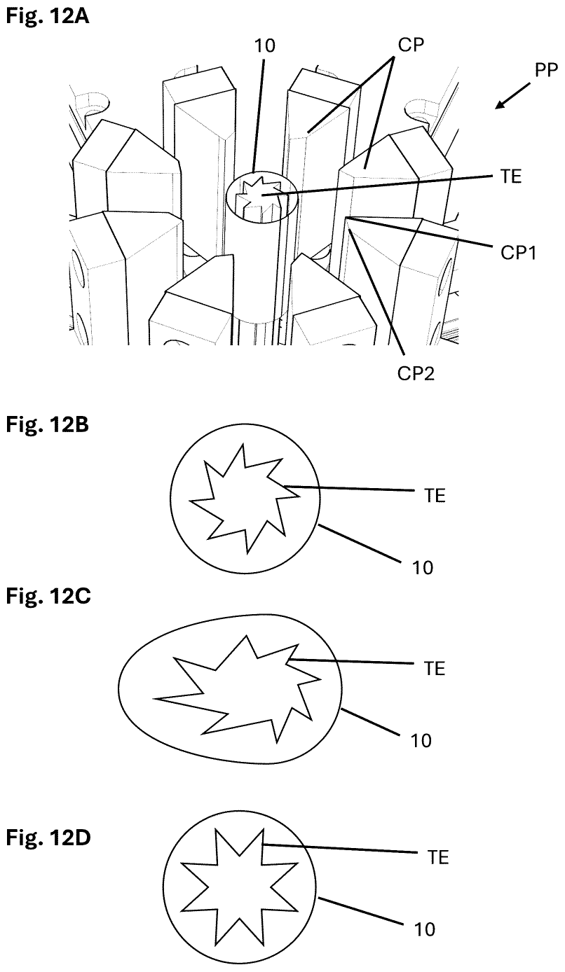

FIG. 12A depicts an enlargement of FIG. 11, FIGS. 12B, 12C and 12D depict the views from above of various embodiments of the pre-folding tool with its star-shaped rod and the sheet of the implant slipped around it;

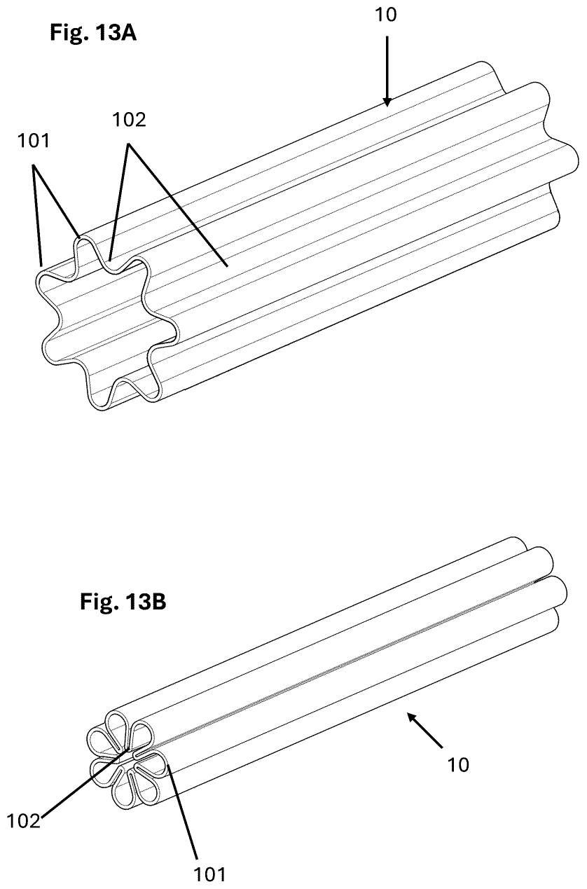

FIG. 13A depicts a perspective view of a sheet that has been pre-folded using a star-shaped rod such as that of FIG. 12D, and FIG. 13B depicts this same sheet folded on itself, according to certain embodiments, FIG. 13A depicting a view from above of a vertebra in which an implant is being implanted according to various embodiments;

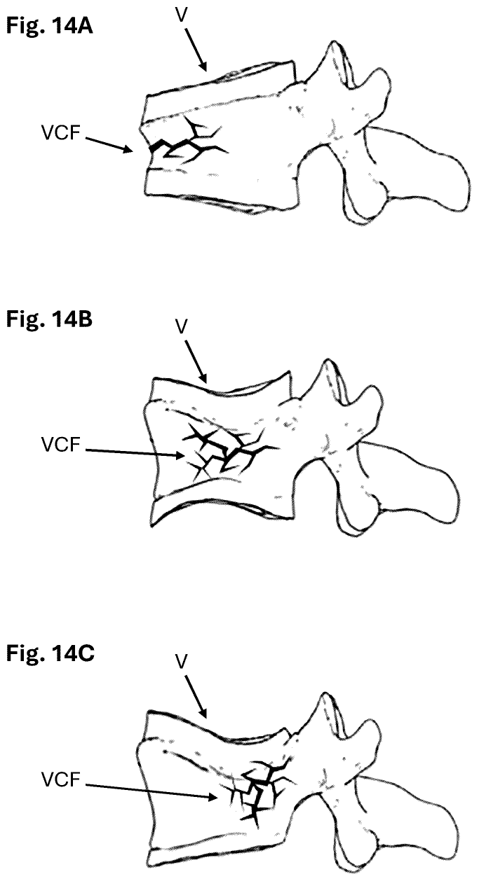

FIGS. 14A, 14B and 14C show profile views of vertebrae that have respectively suffered anterior, median and posterior vertebral compression fractures (VCF);

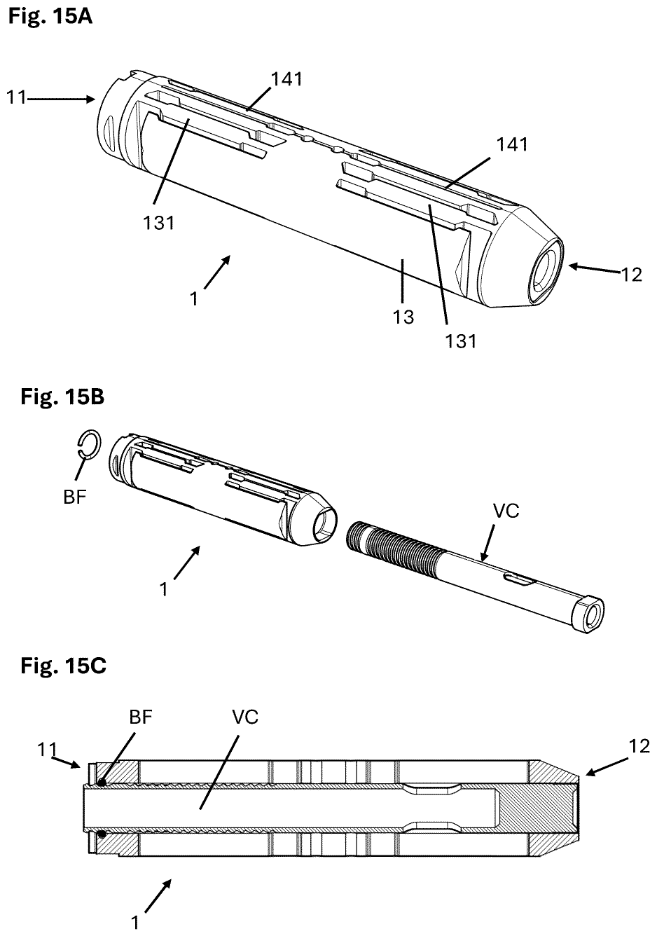

FIG. 15A depicts a perspective view of an implant without its sheet according to certain embodiments and FIG. 15B depicts this same implant from which the expansion rod has been removed and FIG. 15C depicts a cross-sectional view of FIG. 15A in which the expansion rod is present.

The present application relates to an implant and an orthopaedic surgery system for treating fractures in bone and bone tissue in general, and to a method for manufacturing the implant. The bone implant is preferably a spinal implant, and in particular a vertebral or even in fact intervertebral implant, although other uses elsewhere than in the spine (intervertebral discs) or in other bony structures where it is necessary to fill a space left vacant as the result of a fracture (the causes of which may be various, even though they generally imply a reduction in bone density) are conceivable. Thus, vertebral compression fractures (VCFs) are a favourite application but are not the only conditions that can be treated using the present invention, and the person skilled in the art will appreciate the possibilities offered without requiring further details here. In terms of other bones, mention may be made of the femur or the humerus (humeral head), for example in the event of a risk of collapse. This application relates to an implant and a veterinary orthopedic surgery system for treating fractured bones and bone tissue in general, as well as a method for manufacturing the implant. The bone implant is preferably a spinal implant, and in particular a vertebral or even intravertebral implant, but other uses are possible elsewhere in the spine (intervertebral spines) or in other bone structures where it is necessary to fill a space left by a fracture (the causes of which may vary, although they generally involve a decrease in bone density). Thus, vertebral compression fractures (VCFs) are a favorite application, but they are not the only ones that can be treated with the present invention, and those skilled in the art will appreciate the possibilities offered without further detail here. Other bones include the femur or humerus (head), for example, in cases where there is a risk of collapse. In the veterinary field, it is known that animals sometimes have bone densities that are very different from those of humans and, above all, vary greatly depending on the species and even on the breed or animals within the same species, particularly in the case of dogs, whose physical properties vary enormously from one breed to another. For example, dachshunds and similar breeds have long (tall) vertebrae but are not very wide compared to other species. It is therefore useful to have expandable implants that allow for significant expansion in height while having a reduced length, and it is clearly necessary to take into account the differences in the shapes and sizes of the bones of different species in order to adapt the therapy effectively with suitable implants. In addition, some species, such as cats, have very rigid cortical bone but more flexible cancellous tissue than other species. It is therefore also necessary to take into account the nature of the bone tissue. Finally, another notable example concerns horses, which have bones, particularly vertebrae, with a specific anatomical shape and which sometimes bear a heavy load. Depending on the activity (e.g., sports) and morphology, bone density varies and implants must be adapted to allow for expansion but also to bear loads. Thus, for a horse, it may be necessary to have implants with more load-bearing arms (at least 3 or 4) than for other species (where 2 support arms are sometimes sufficient). In the absence of support arms, the implant must have sufficient mechanical strength, thanks to its ability to withstand higher cement pressure than in other cases.

In addition, the tibial plateau is frequently subject to crushing, and the implants or systems of the present application are useful for restoring height in any type of bone crushing or collapse, for example in the distal part of the humerus or femur. On the other hand, as taught, for example, in document EP2921142, it is possible to use expandable implants as bone anchoring implants, and such use is also possible for implants such as those of the present application. In this case, the implants will be extended at their proximal end by an elongated body to which another orthopedic implant of another type or a surgical device for fixing other elements can be attached. Nevertheless, in the case of use as a bone anchor in a vascularized structure, such as a humeral or femoral head, the size of the implant will preferably be limited in relation to the bone structure in order to preserve vascularization and promote bone healing.

Certain embodiments provide for the injection of a fluid (e.g. “bone cement”, which is generally based on a polymer such as PMMA, for example, and is well known to those skilled in the art, and therefore no detail on the cement will be given here). Thus, once positioned, the implant can be stabilized by such an injection of cement. However, because cement leakages are a major problem in this field, various embodiments propose containing the cement in a fluidtight casing, the post-injection volume of which can be controlled by virtue of the structure and the material of the casing, as a function of the injected pressure (and the configuration of the bone tissue, preferably assessed in advance, as is the general practice in this field). Fluidtightness is of course relative and this term is not limiting either, since the level of fluidtightness is in fact adapted to the viscosity of the cement at the moment of its injection. Certain embodiments in particular allow a proportional expansion of the casing as a result of the (relative) flexibility of the sheet (10) of biocompatible metallic material. This material is generally a titanium alloy obtained in the form of a very thin sheet, preferably by rolling to give a controlled surface condition and a controlled thickness, notably a thickness comprised between 3 and 100 microns, generally between 6 and 50 and preferably 10 and 30 microns. In general, the present invention uses at least one sheet (10) made of biocompatible metal or biocompatible metal alloy, such as titanium or its alloys, particularly with nickel or others, but also nitinol or stainless steel or their alloys. Advantage is taken of recent techniques for obtaining very thin sheets of such metals, in particular with a thickness of less than 50 or even 40 μm, which makes it possible to obtain relatively flexible and elastic sheets, but above all, which can be plastically deformed in a reversible manner without reaching their tear limit, by creating folds arranged longitudinally on the implant. In particular, it is possible to provide a maximum unfolded volume that is greater than the volume required for the desired applications, so that this limit is never reached and it is possible to fold and then unfold the implant, even several times (for example, in the event of incorrect positioning of the implant), without the risk of uncontrolled tearing and leakage. Thus, thanks to this type of sheet and the configuration of their interlocking folds, it is possible to obtain expansion ratios between the folded volume and the unfolded volume ranging from 2 to 20, or even 30, and it is also possible to control the shape of the implant in its deployed configuration, depending on the arrangement of the folds, in the same way as origami. Finally, although one of the main goals here is to prevent cement leakage, it may sometimes be useful to control the release of cement outside the implant, so that we no longer refer to leakage but rather to controlled release, for example to allow adhesion to certain surrounding structures (usually bone structures). Similarly, since the injected fluid is not necessarily cement (or at least not the fluid that will come out of the implant), it may in fact be useful to administer molecules through such controlled release of this fluid. Thus, various embodiments provide for a certain porosity of the sheets (10) at least in certain portions of the implant, for example through holes of controlled microscopic size and controlled number and density. In any case, this sheet is capable of reversible plastic deformation a number of times that is satisfactory for the target application since it notably offers the possibility of retracting the casing formed by the sheet in the event of a problem (biocompatibility and resistance to tearing). Specifically, in general, controlling the metering of the cement allows monitoring for the fifteen minutes of polymerization time during which it is possible to retract the casing and aspirate the cement. Furthermore, through the injection of cement and the expansion of the casing, the implant fills the spaces in the damaged tissues according to the compression and bone-resistance forces relative to the hydraulic pressure supplied during the injection of cement. From such a sheet, it is necessary to obtain a closed structure, which already means that the sheet needs to be closed on itself and locked in position. To do that, welding (or bonding or brazing, these terms being nonlimiting here) may be used to join together two superposed edges or edges with interlocking turn-ups, to facilitate the welding and make it more robust. Certain embodiments therefore envisage closure by welding from the outside, which is simpler and more robust because of the superposition of layers at these complementary folds.

Various embodiments make it possible to obtain an expandable implant with very small dimensions in the folded configuration while at the same time guaranteeing a satisfactory volume in the deployed configuration. Thus, the passage required to introduce the implants of the present application is generally smaller than that of the known implants, whereas the expansion is greater than that of these known implants. Specifically, the folded volume or diameter is smaller than the deployed diameter by a factor of between 3 and 20, generally 3 to 8, preferably 4 to 7. This ratio depends of course on the amount of cement injected and certain embodiments take advantage of the fact that it is possible to provide an implant that is capable of deploying more than necessary, in particular by retaining folds in the deployed configuration. Thus, the volume of the implant will be determined based on the reduced size required for the introduction into the bone tissue and therefore with reference to the folded volume. However, different volumes are provided for the deployed configuration, since the number of folds and the length of the folds make it possible to increase the deployment ratio.

The term “secured” here means the two elements are secured to one another, either permanently (or near-permanently) but also sometimes that a connection is made so that one element can be actuated by another. Thus, screw-fastening or collaboration between shapes for temporarily locking the elements together are covered by this nonlimiting term.

The terms “ring”, “sleeve”, or “tube” refer to hollow structures such as bands, conduits or pipes, but nonlimitingly, notably having various shapes (on the inside as on the outside), although a cylindrical shape is preferred. The term “canal” by contrast is preferably used here to refer to a passage rather than to the element that contains it, and the term “opening” here refers to the fact that an element is open and able to be passed through, opening out into another structure or another element. In general, the terms “sleeve”, “tube” or “conduit” refer to longer elements than rings or bands, although their use here is likewise nonlimiting. Furthermore, the terms “socket” or “cup” refer also to hollow structures that are open at one end but closed at the other end, such as plugs, closures, constrictions or restrictions, and these terms are used indiscriminately without any limitation.

The term “hinge” is used here in its functional sense without implying any structural limitation, and may in fact refer to mechanical hinges even though these are preferably formed (as illustrated in the non-limiting examples in the figures) by thinning (or narrowing, removing material from) elements such as the support arms or other elements. Thus, a hinge is in fact an articulation point or region since it is known in the art that there is generally no danger associated with providing such pivot mechanisms in implants because the materials of which they are made are suited to this type of articulation.

The terms antiform fold, referred to as convex, and synform fold, referred to as concave, are used by analogy with the definitions of folds in numerous technical fields, including that of geology, but it will be appreciated that convexity is defined in this case with respect to the outside of the implant. An antiform or convex fold is therefore a fold that turns the material inwards, while an antiform fold turns the material outwards. The succession of the two types of folds makes it possible to limit as far as possible the volume that is folded. In addition, certain embodiments envision a succession of long folds and of short folds making rolling and/or compaction easier by limiting the extent to which material is superposed in the folded configuration. To make it easier to roll the sheet (10) on itself and obtain a smaller folded volume, it is preferable to envisage an alternation of long folds and short folds. To do that, it is possible to use pre-folding cams (CP) having two edges at different angles, with a star-shaped rod (TE) likewise of asymmetric shape complementing the first angle (CP1) of the pre-folding cam and the second angle (CP2) of the pre-folding cam, as for example depicted in FIGS. 11, 12A, 12B and 12C, but it is also possible to have pre-folding in a symmetrical shape, as for example depicted in FIGS. 12D, 13A and 13B, although these embodiments gave less-advantageous folding than asymmetric folding with an alternation of long folds and short folds.

Generally, it is understood that the implant will retain, even in the deployed configuration, at least some of the folds of the sheet near the proximal and distal ends, but the dimensions and strength properties of the sheet (10) used allow the implant to be obtained and ensure that these persistent folds do not interfere with function or cause mechanical or physiological problems in the bone tissue.

It will also be noted that the number of folds is not limiting either but that it instead makes it possible to maintain the irregularity or trueness of shape of the implant as it deploys, this likewise offering advantages, in particular in terms of stabilization. In addition, it is still preferable to have an even distribution of surface areas between the folds for uniform deployment allowing uniform deployment, although the invention also envisions other applications and notably folds of different sizes depending on the region of the implant, so as to obtain asymmetric deployment and better therapeutic outcomes. Moreover, the present invention makes it possible to control the shape of the implant once deployed by also setting the distance between the folds. Specifically, the distance between the synform/antiform folds, and therefore the distance between the long folds and the short folds, governs the way in which it deploys. Advantageously, if the density is greater at one point on the periphery, deployment will be greater and if it is lower, the casing will be able to deploy to a lesser extent. It will be appreciated that asymmetry and curving is thus obtained by more extensive deployment in regions that have the greatest folds content. Likewise, it is possible to envisage more material (a larger surface area of sheet) on one side for example so the lateral expansion will be greater on this side than on the other. Moreover, in certain embodiments, the sheet is welded to the flanges and is therefore unable to deploy further than the distance between the flanges, which distance will have been set by the lever mechanism. What is thus obtained is an implant the expansion of which is limited in one dimension (in general the essential dimension in which a precise height or width is to be restored) but not in another dimension, so that the injection of cement will deploy the casing into the volumes of low bone density that may be present around the implant. It will also be noted that the fluid injection instrument (Ac) may be fitted with means for controlling the injected pressure (a pressure gauge for example) and for indicating the resulting volume so that the expansion into the bony tissue can be controlled effectively. Finally, it will be appreciated that the instrumentation proposed in the present application in certain embodiments, using an implant holder (or ancillary) of relatively conventional type to hold the implant and introduce it into the bony tissue, but also of less-conventional type for expanding it into the bony tissue, also offers the advantage that all the implantation and stabilization steps can be carried out using just one single instrument and in a continuous operation. Specifically, the ancillary with a hollow tube for conveying cement through the tube that holds the cement makes it possible to offer an instrument that allows the surgical intervention to be performed quickly and efficiently. After drilling, the implant is introduced and, without withdrawing the instrument, the casing can be inflated with the cement and then the tool can be withdrawn before, during or even after the polymerization of the cement (for example using a mechanism for cutting the hardened cement as the instrument rotates). The time taken to perform the surgical operation is of course markedly reduced as also the stability of the implant which is not released at any time until it has been stabilized by the injection of cement filling all the free volumes around it, unlike in certain solutions of the prior art.

The terms “cylinder”, “cylindrical” or “generalized cylinder” are used in the present application indiscriminately to make the invention easier to explain and in fact all refer to a “generalized cylinder”, which is to say a three-dimensional shape defined by a height (parallel to the longitudinal axis) and two bases (transverse to the longitudinal axis) which may have any shape whatever, even though a circular shape is preferred in order to simplify the manufacture and limit the risk of lesion of the tissue into which it is introduced. Preferably, this “cylinder” is a right cylinder, which is to say that its bases are aligned with respect to the generatrix (or height) of the cylinder. Furthermore, because the implant may deploy in a tissue to conform to the shape of the space into which it has been introduced (modifying this thanks to the pressure it exerts on this tissue), it is possible for the shape not to be constant so the two bases of the cylinder may have different shapes (areas).

As a result, the term “diameter” is used, in the present application, to refer in fact to the longest dimension of the generalized cylinder transverse to the height (or longitudinal axis) thereof, namely in a plane (referred to as “transverse”) parallel to that of the bases of such a generalized cylinder. Thus, the term “diameter” may in fact refer to the length of the diagonal of a square or of a rectangle or else (for any arbitrary shape) to the longest distance between two points included in such a transverse plane and lying on the circumference of such a cylinder. Likewise, the terms “circumference”, “periphery” or “perimeter” are used here to refer to the perimeter of these bases of any arbitrary shape.

Likewise, the terms “conical” or “frustoconical” are used here to denote shapes that widen from a minimum “diameter” (or surface-area/surface) up to a maximum “diameter”, but they do not imply any limitation as to the shape of the parameter which may or may not be circular.

In general, the present application relates to an expandable bone implant (1) for veterinary orthopaedic surgery for restoring the volume and/or geometry of a bone, by expansion between a folded configuration and a deployed configuration, said implant (1) extending along a longitudinal axis (L) between a proximal end (11) that can cooperate with an implantation instrument (A) for holding the implant and a distal end (12) intended to be inserted first into the bone, at least two faces, for example an upper and a lower face, of the implant each comprising a flange (13, 14) for contact with bone tissue, each of the flanges comprising a central portion (130, 140) connected, by means of at least one hinge, to at least one pair of support arms (131, 141) each oriented in opposite directions within each pair, one arm of each pair being connected by a hinge to the distal end (11) while the other arm is connected by a hinge to the proximal end (12), the implant (1) being able to receive or comprising a central shaft (3) extending through a sliding sleeve at the proximal end (11) as far as a traction ring or socket at the distal end (12) where it is able to transmit traction, when actuated by an instrument (A), to the distal end (12) in order to allow it to move closer to the proximal end (11), causing the support arms (131, 141) to pivot, thus causing the flanges (13, 14) to move away from one another and, consequently, the expansion of the implant between the folded configuration and the deployed configuration, characterized in that it comprises a casing enclosing said implant from the proximal end (11) to the distal end (12) and in that:
said casing is formed by a sheet (10) made of a biocompatible metal alloy and fluidtightly closed on itself;
said sheet (10) has, at least in the folded configuration, a plurality of pairs of folds, each of the pairs comprising an antiform fold (101), referred to as convex, and a synform fold (102), referred to as concave, said folds lying one on top of another in the folded configuration such that the surfaces present between each of said convex and concave folds are rolled around the longitudinal axis (L);
said proximal end (11) is extended by a fluidtight sleeve fluidtightly secured to the lying-down and rolled folds of said sheet (10) over the entire periphery of the proximal end (11);
said distal end (12) is extended by a socket fluidtightly secured to the lying-down and rolled folds of said sheet (10) over the entire periphery of the distal end (12) of said implant (1);
said sheet (10) is plastically deformable to allow the expansion of the implant from the folded configuration to the deployed configuration, forming a fluidtight casing enclosing the implant and making it possible to avoid any leakage when a fluid is being injected into the implant (1) and the casing.

In certain embodiments, the distance between a synform fold and the next antiform fold is longer than the distance between an antiform fold and the next synform fold to make it easier to roll the folds around the longitudinal axis (L) of the implant in the folded configuration.

In certain embodiments, said fluidtight sleeve extends said proximal end (11), parallel to the longitudinal axis (L), to a distance that is greater than or equal to that to which the flanges extend from the centre of the implant (1).

In certain embodiments, said fluidtight sleeve has a through-opening of which the diameter is greater than or equal to that of the opening of the sliding sleeve, so that these two sleeves, the fluidtight sleeve and the sliding sleeve, form an entrance to the inside of the hollow body of the implant (1) from a conduit of an implantation instrument (A) holding the implant at the proximal end, able to convey a fluid that is to be injected into said implant.

In certain embodiments, in the deployed position, the implant comprises a middle portion between its two ends that has the shape of a generalized cylinder of a length greater than or equal to that of the flanges, with possible and partial persistence of said folds, said middle portion being extended, at the proximal end (11), by a frustoconical portion connecting the middle portion to the sleeve and, at the distal end (12), by a frustoconical portion connecting the middle portion to the socket, the frustoconical portions having a permanent persistence of at least part of the lying-down and rolled folds near the proximal end (11) and distal end (12).

In certain embodiments, said sheet is plastically deformable also from the folded configuration to the deployed configuration, without tearing the sheet thanks to the thinness of the sheet and in particular as a result of the persistence of the lying-down and rolled folds at the proximal and distal ends, making it easier to reverse the expansion.

In certain embodiments, said central shaft (3) is able to cooperate with and/or is extended beyond the distal end of an implantation instrument (A) at the proximal end of the implant and having an interior conduit in communication with a conduit (31) formed in said central shaft and opening onto the space formed by the parting of the flanges, via at least one opening (32) allowing said fluid to be injected into the implant (1). As is known, the instrument may include an expansion rod (A3) mounted freely in the instrument and allowing the implant to be activated by bringing the distal end closer to the proximal end to achieve expansion.

In certain embodiments, said sheet (10) is secured at the proximal end (11) to the proximal end of the flattened and rolled folds, which is welded to the outer wall of said sliding sleeve by a weld (110) and/or secured at the distal end (12) to the distal end of the folds laid flat and rolled up against the outer wall of said pull-out sleeve by a weld (120).

In certain embodiments, said sheet is compressed around the sleeve of the proximal end (11) and/or around the socket of the distal end (12) by a compression ring (121) that holds the lying-down and rolled folds against the exterior wall of said sleeve and/or of said socket.

In certain embodiments, the folds are, at least in the folded configuration, parallel to the longitudinal axis (L).

In certain embodiments, the sheet also comprises at least one pair of folds (a synform fold and an antiform fold) of axis not parallel to the longitudinal axis (L), preferably perpendicular so that the implant can expand also lengthwise, or oblique so that the implant can expand in a curved manner.

In certain embodiments, the number of pairs of folds is between 3 and 16, generally 4 to 2, and preferably of around 8. However, 3 folds may sometimes be sufficient, particularly for small implants for small animals or small bones. However the greater the number of folds, the less the material will deform, the less risk there will be of tearing, and the easier it will be to unfold. It is therefore possible to use up to 20 folds, even for medium-sized animals, and when it comes to large animals such as horses, it is possible to allow for 25 to 30 folds, or even more.

In certain embodiments, the sheet (10) has a thickness of between 3 and 100 microns, generally between 6 and 50, and preferably 10 and 30 microns.

In certain embodiments, the sheet (10) is made of titanium alloy.

In certain embodiments, the distance between the folds is variable from one lateral face of the implant to the other, so that the shape of the implant in the deployed configuration is curved and/or asymmetric transversely to the longitudinal axis (L).

In certain embodiments, at least part of the support arms is provided in duplicate. Specifically, in particular in order to limit the risks of non-regular expansion of the flanges, on account of the support arms in force opposition and the external stresses applied to the implant, it is preferable to provide support arms in duplicate, for example as depicted in FIGS. 4A, 4B, 6A and 6B.

In addition, such double arms may comprise a self-locking mechanism that locks them in the deployed configuration, such as teeth formed facing one another so that they engage with one another, for example as depicted in the enlarged box in FIG. 4A.

Furthermore, in order to further improve the reliability and symmetry of the expansion, it is possible to provide support arms that are offset towards the ends of the flanges instead of the single support arms that are articulated at the centre of the flanges, for example as depicted in FIG. 7B. Such a configuration makes it possible to create deformable parallelograms that retain their property of parallelism between their sides, thus making the expansion more reliable.

Other embodiments are possible as regards the support arms, with in particular arms which are opposed (intersect) only from one face of the implant to the other but which have the same orientation on a given face, as depicted for example in FIG. 7A, but this type of embodiment is not preferred because of the risks of the implant twisting during the expansion.

As regards actuation and locking, it should be noted that the very narrow diameters of the implants and their central shafts are not easily compatible with screw threads for expanding by means of a screwing action at the implant, although it is advantageous to perform a screwing action at the instrument actuating the expansion, in particular when the expansion involves bringing the support arms closer to one another. Thus, as is known from the prior art, it is possible to use for example a split ring that is housed in a circular recess of the implant and interacts with teeth on the push- or pull-shaft, said teeth being oriented in such a way as to allow this shaft to turn in just one direction, for example as depicted in FIGS. 15A, 15 and 15C. Thus, the shaft may be actuated for expanding the flanges by rotating past successive teeth, thereby allowing the implant to be locked in the deployed configuration.

Additionally, the present application also relates to a system for orthopaedic treatment of damaged bone tissue, comprising a bone substitute cement and at least one instrument (A) for implantation and for injection (Ac) of cement into the implant (1), characterized in that it comprises an implant (1) according to one of the embodiments described in the present application.

In certain embodiments, the instrument for implantation and for injection of cement comprises means for controlling the pressure and/or the aspiration of the cement so that the implant can be folded into the folded configuration if necessary.

In certain embodiments, the implantation instrument is distinct from but complements the injection instrument of which the cement-injection canal passes through a canal inside that rod of the implantation instrument that holds the proximal end of the implant via its distal end.

Additionally, the present application also relates to a method for manufacturing an implant according to various embodiments, characterized in that it comprises:
obtaining an expandable implant with two flanges that can be parted under the effect of the ends of the implant being moved closer together by support arms that connect these ends to the flanges;
closing the sheet on itself and welding to form a generalized cylinder;
inserting the closed sheet on a die in the shape of a generalized cylinder having a star-shaped base and referred to as star-shaped rod (TE), the number of branches of the star defining the number of pairs of folds of said sheet of said implant;
compressing the closed sheet between said die and a plurality of protruding elements of complementary shape to the recesses between the branches of the star;
rolling the folds of said sheet around the longitudinal axis;
inserting said expandable implant into said compressed sheet;
securing said sheet on the socket and the sleeve.

For example, rolling may be achieved by introducing the closed and pre-folded sheet into a conduit the diameter of which narrows progressively down to the desired diameter for the implant, by sliding and twisting the implant in this conduit (for example with a guide inside the sheet to prevent it from becoming crushed).

The act of securing to the sleeve and the socket will generally be achieved using welding (120), preferably with the sheet being crushed beforehand onto the circumference of the socket or the sleeve, for example by means of a compression ring (121), examples of which are depicted in certain figures. Specifically, while it is possible to weld directly, compressing the folds in place remains preferable.

The illustrative and nonlimiting figures of the present application will now be described in detail the better to explain the various embodiments and provide examples of structural elements that can be used in the foregoing context. That which follows must not be considered as being limiting since the various elements or components illustrated are merely examples and the figures may combine elements or components that are not necessarily dependent on one another.

In certain embodiments, the implant comprises a ring at the proximal end and a cup at the distal end, the respective dimensions of which are provided in relation to the total size of the implant such that the sheet welded to the ends can be deployed when the flanges are being parted while still keeping a shape that limits the risks of tearing of the casing formed by the sheet. Specifically, in the folded configuration, the sheet has an equivalent length between these ends of the implant to which the sheet is welded, but shortening the implant when the flanges are being parted allows the sheet to follow the overall shape of the implant when being deployed. It will be understood that the sheet and the rest of the implant, in particular its proximal and distal ends, have respective dimensions which are complementary such that the parting deploys the sheet forming the casing without tearing it. It should be noted that in certain embodiments, as shown for example in FIGS. 4B and 12C, the implant may be asymmetrical and allow asymmetrical and controllable expansion, by way of the shape of the arms and, after the flanges have deployed, by way of the shape of the casing which may be provided to follow the deformation induced by the expansion of the implant when the flanges are being parted from one another. In addition, it is possible to provide a casing which is capable of deforming beyond the shape imposed by the deployment of the implant in certain embodiments, for example for expansion of the casing alone, for example laterally (i.e. perpendicularly to the direction of expansion by the parting of the flanges).

In certain embodiments, the implant may comprise a second sheet (10b) surrounding the first sheet, made from the same material or another material, to form a double casing, for example as depicted in FIG. 3B. Such a double casing may offer numerous assorted advantages, particularly of providing thermal insulation to protect the tissue from the heat of polymerization (thanks for example to a fluid that limits the transmission of heat) or simply of providing additional safety to ensure that cement does not leak out if one of the sheets becomes torn. In that case, at least one of the ends of the implant, in particular the proximal end (11), may comprise an additional ring or cup concentric with the first ring or with the first cup or, for example as depicted in FIG. 3B, a double ring (11b), for fixing this second sheet (10b), keeping a space between it and the first sheet (10), but it is possible to secure them together at the ends. In the case of two more widely spaced sheets, it is possible to provide an injection inlet, for injecting, between the two sheets (10, 10b), a fluid different from or identical to the first, for example by means of spacers between the first proximal ring (11) and the second ring (11b) which are concentric and thus form a conduit of annular cross section between them, for the injection of this second fluid (such as for example a lubricating fluid that improves the sliding of one sheet relative to the other and thus facilitates deployment). Of course, other configurations are possible as long as they include a duct opening into the envelope formed by the first sheet and a duct opening into the space between the two sheets. During manufacture, these two sheets can then be folded and rolled at the same time or successively, but their welds (or crush joints) between themselves and/or to the ring and/or to the base shall be made successively to ensure that the space between them is maintained. These double-sheet methods enable the injection site to be preformed (by compressing spongy bony tissue) but can also enable, for example, said fluid to be injected in two stages for better adjustment of the shape, of the resulting temperature in the tissue and/or of the rate of polymerization of the fluid (for example by adjusting the mix of the compounds of the cement). On the other hand, since it is possible to use a second fluid other than cement inside, it is possible to use the compartment between the two sheets as a cooling circuit by circulating a fluid during cement polymerization, so as to protect the tissue from the heat generated during said polymerization. Such a double-sheet implant (1) therefore requires a double cannula comprising two concentric conduits each opening into one of the spaces formed by each of the sheets, via the double proximal ring (11, 11b), as the person skilled in the art will appreciate from FIG. 3B without further explanation being required.

FIG. 7A depicts a known implant of the prior art in which the deployment arms are disposed asymmetrically on one face of the implant in relation to the other, with arms connecting a single flange to only one end while others connect the other flange to the other end, this type of implant also being able to be used in the context of the present invention provided that a casing A sheet will be welded to the ends with dimensions that are sufficient to form a deformable casing as described in the present application.

FIG. 8A depicts a perspective view of an expandable implant in a semi-deployed configuration, according to certain embodiments, FIG. 8B depicts a perspective view of a sheet used for the manufacture of an expandable implant according to certain embodiments in the semi-folded configuration, and FIG. 8C depicts a perspective view of this same sheet in the folded configuration.

FIG. 9A depicts a perspective view of an expandable implant in the folded configuration with a line (110) of welding at the proximal end (11) and a line (120) of welding at the distal end (12), and FIG. 9B depicts an enlargement of FIG. 9A at the distal end, showing the distal cup that closes off the distal end of the implant.

FIG. 10A depicts a perspective view of a guide tool that guides the folding of a sheet of an expandable implant according to certain embodiments, the sheet being guided by means of a guide tube, and FIG. 10B depicts a profile view of this same tool with the sheet folded, the enlargements 10C and 10D depicting profile views of the overlapping of the sheet at its closure according to two different examples of embodiment. In order to obtain a sheet (10) that is folded on itself in the shape of a cylinder, use is preferably made of an internal guide (TG) as for example a guide tube (but potentially a roller of which the relative position with respect to the sheet is preferably able to move parallel to the longitudinal axis). This guide allows the sheet (10) to be rolled up on itself and introduced into an external guide (GR), as for example a folding guide comprising a conduit to accept the folded sheet as illustrated for example in FIG. 10A, or an external roller preferably able to move in a manner complementary to the internal guide, so as to enable welding as the rollers gradually progress along the longitudinal axis that corresponds to the height of the cylinder. Guiding the sheet using at least one of the internal and external guides enables the two edges (or ends) of the sheet (10) initially of rectangular shape and bent round on itself to be positioned in such a way that two of its edges are partially superposed. These edges positioned one above the other may then be welded together, for example as depicted in FIG. 10C, but it is possible to create 2 folds in opposing directions on each of these two edges of the sheet in order to obtain interlocked folds, for example as depicted in FIG. 10D, this making the welding easier particularly by limiting the risks of holing the sheet and/or making it possible to improve the reliability and stability of the implant particularly at the time of its subsequent deployment.

FIG. 11 depicts a perspective view of a tool for the pre-folding of sheets for the expandable implant according to certain embodiments, using a pre-folding plate. This FIG. 11 illustrates a preferred embodiment of a tool enabling the creation of an alternation of long folds and short folds or an alternation of symmetrical folds depending on the shape of the ends of the pre-folding cams (CP) that collaborate with a complementing star-shaped rod for pre-folding the sheet between the rod and the cams. Specifically, certain embodiments of such a tool have rails (RC) bearing pre-folding cams (CP) which may have a first cam angle (CP1) and a second cam angle (CP2) that are different so as to obtain long folds and short folds, or two cam angles that are identical in order to obtain symmetrical folds. The folding cams, by sliding along their respective cam rail, enable the sheet (10), previously closed on itself in cylindrical form, to be deformed (e.g. crushed) and pre-folded. To do that, this sheet (10) is inserted over a star-shaped rod (TE) the cross section of which has the shape of a star with asymmetrical branches in the case of long folds and short folds, or with symmetrical branches in the case of symmetrical cams and folds, as illustrated in FIGS. 12B and 12D respectively.

FIG. 12A depicts an enlargement of FIG. 11, FIGS. 12B, 12C and 12D depict the views from above of various embodiments of the pre-folding tool with a star-shaped rod and a sheet of the implant slipped around it. In the enlargement of part of FIG. 11 that is FIG. 12A, it is easier to see how the pre-folding cams and the star-shaped rod collaborate. FIG. 12C depicts a variant embodiment in which the star-shaped rod has branches the dimensions of which vary around the circumference of the star-shaped rod, which means that the corresponding cams will have shapes that differ from one cam to another, whether for obtaining long folds and short folds as in the example depicted, or symmetrical folds, so that the folded sheet in the form of an asymmetric flattened cylinder will, once pre-folded by this tool, have an asymmetrical shape that it will maintain also once deployed.

FIG. 13A shows an example of a folded sheet in the form of a cylinder that has been pre-folded with symmetrical folds, and FIG. 13B shows this same sheet condensed in on itself to reduce its diameter, for example to reduce it as far as possible until its internal folds (102) are adjacent to one another. It will be noted that in such an embodiment it is also possible to reduce the diameter of the casing formed by the sheet, for example by introducing it into a tapering tube or some other means for compressing the periphery of the sheet and notably the external folds (101).

FIGS. 14A, 14B and 14C depict profile views of a vertebra fractured in the anterior portion, in the median portion and in the posterior portion, respectively. The invention allows this kind of vertebral fracture to be treated by arranging the deployable implant in the correct position in the plane of the implantation site, using antero-posterior and/or medio-lateral positioning and adjusting the depth of insertion and/or the angle of insertion of the implant, according to the type of surgical approach being used (for example lateral, anterior, dorsal, transforaminal, transpedicular, etc.).

FIG. 15A depicts a perspective view of an implant without its sheet according to certain embodiments and FIG. 15B depicts this same implant from which the expansion rod has been removed and FIG. 15C depicts a cross-sectional view of the implant of FIG. 15A in which the expansion rod is present. FIG. 15A depicts an embodiment in which deployment is achieved by a mechanism known from the prior art. As illustrated in FIG. 15B, this mechanism comprises a toothed lock (VC) containing a circumferential groove that can receive a split ring acting as a locking clip intended to cooperate with a circumferential housing inside the conduit into which the toothed lock is inserted to form this clip. As depicted in FIG. 15C, as the toothed lock is pulled out, the split ring cooperates with teeth in the conduit of the implant, which can thus be locked incrementally by this lock pressing against interior teeth in the conduit of the implant. These teeth are preferably asymmetrical so as to allow the lock to be withdrawn only towards the outlet, thereby keeping the implant secure in the deployed position and preventing it from re-folding under the force exerted by the surrounding tissue.

The present application describes various technical and advantageous features with reference to the figures and/or to various embodiments. The person skilled in the art will appreciate that the technical features of one given embodiment may in fact be combined with features of another embodiment unless the contrary is explicitly mentioned or unless it is obvious that these features are incompatible or that combining them will not provide a solution to at least one of the technical problems mentioned in the present application. In addition, the technical features described in one given embodiment may be taken in isolation from the other features of this embodiment unless the contrary is explicitly mentioned.

### DETAILED LIST OF REFERENCES IN THE FIGURES

1 implant
10 sheet
10b second sheet
11 proximal end
11b double ring
101 antiform fold
102 synform fold
110 proximal weld
12 distal end
120 distal weld (fluidtight connection)
121 compression fixing (e.g. split ring)
A implantation instrument
A12 distal end-cap
TG internal guide
GR external guide
PP pre-folding plate
ET star-shaped rod
CP pre-folding cam
CP1 pre-folding cam first angle
CP2 pre-folding cam second angle
RC cam rail
3 central shaft
31 central-shaft conduit
32 openings in the central-shaft conduit
13 first flange
14 second flange
130 first-flange central reinforcement
140 second-flange central reinforcement
131 first-flange support arm
141 second-flange support arm

1. An expandable bone implant (1) for veterinary orthopaedic surgery for restoring the volume and/or geometry of a bone, by expansion between a folded configuration and a deployed configuration, said implant (1) extending along a longitudinal axis (L) between a proximal end (11) connectable with an implantation instrument (A) for holding the implant and a distal end (12) intended to be inserted first into the bone, at least two faces, for example an upper and a lower face, of the implant each comprising a flange (13, 14) for contact with bone tissue, each of the flanges comprising a central portion (130, 140) connected, by means of at least one hinge, to at least one pair of support arms (131, 141) each oriented in opposite directions within each pair, one arm of each pair being connected by a hinge to the distal end (11) while the other arm is connected by a hinge to the proximal end (12), the implant (1) being able to receive or comprising a central shaft (3) extending through a sliding sleeve at the proximal end (11) as far as a traction ring or socket at the distal end (12) where it is able to transmit traction, when actuated by an instrument (A), to the distal end (12) in order to allow it to move closer to the proximal end (11), causing the support arms (131, 141) to pivot, thus causing the flanges (13, 14) to move away from one another and, consequently, the expansion of the implant between the folded configuration and the deployed configuration, wherein the implant comprises a casing enclosing said implant from the proximal end (11) to the distal end (12) and in that:
said casing is formed by a sheet (10) made of a biocompatible metal alloy and fluidtightly closed on itself;
said sheet (10) has, at least in the folded configuration, a plurality of pairs of folds, each of the pairs comprising an antiform fold (101), referred to as convex, and a synform fold (102), referred to as concave, said folds lying one on top of another in the folded configuration such that the surfaces present between each of said convex and concave folds are rolled around the longitudinal axis (L);
said proximal end (11) is extended by a fluidtight sleeve fluidtightly secured to the lying-down and rolled folds of said sheet (10) over the entire periphery of the proximal end (11);
said distal end (12) is extended by a socket fluidtightly secured to the lying-down and rolled folds of said sheet (10) over the entire periphery of the distal end (12) of said implant (1);
said sheet (10) is plastically deformable to allow the expansion of the implant from the folded configuration to the deployed configuration, forming a fluidtight casing enclosing the implant and configured to avoid any leakage when a fluid is being injected into the implant (1) and the casing.

2. The expandable bone implant according to claim 1, wherein the distance between a synform fold and the next antiform fold is longer than the distance between an antiform fold and the next synform fold to make it easier to roll the folds around the longitudinal axis (L) of the implant in the folded configuration.

3. The expandable bone implant according to claim 1, wherein said sealing sleeve extends said proximal end (11), parallel to the longitudinal axis (L), to a distance that is greater than or equal to that to which the flanges extend from the centre of the implant (1).

4. The expandable bone implant according to claim 1, wherein said sealing sleeve has a through-opening of which the diameter is greater than or equal to that of the opening of the sliding sleeve, so that these two sleeves, the sealing sleeve and the sliding sleeve, form an entrance to the inside of the hollow body of the implant (1) from a conduit of an implantation instrument (A) holding the implant at the proximal end, able to convey a fluid that is to be injected into said implant.

5. The expandable bone implant according to claim 1, wherein, in the deployed position, it comprises a middle portion between its two ends that has the shape of a generalized cylinder of a length greater than or equal to that of the flanges, with possible and partial persistence of said folds, said middle portion being extended, at the end corresponding to the proximal end (11), by a frustoconical portion connecting the middle portion to the sleeve and, at the end corresponding to the distal end (12), by a frustoconical portion connecting the middle portion to the socket, the frustoconical portions having a permanent persistence of at least part of the lying-down and rolled folds near the proximal end (11) and distal end (12).

6. The expandable bone implant according to claim 1, wherein said sheet is plastically deformable also from the folded configuration to the deployed position, in particular as a result of the persistence of the lying-down and rolled folds at the proximal and distal ends, enhancing the reversibility of the expansion.

7. The expandable bone implant according to claim 1, wherein said central shaft (3) is able to collaborate with and/or is extended beyond the distal end of an implantation instrument (A) at the proximal end of the implant and having an interior conduit in communication with a conduit (31) formed in said central shaft and opening onto the space formed by the parting of the flanges, via at least one opening (32) allowing said fluid to be injected into the implant (1).

8. The expandable bone implant according to claim 1, wherein said sheet (10) is secured to the proximal end (11) by a weld (110) that fixes the proximal end of the lying-down and rolled folds against the exterior wall of said sliding sleeve and/or secured to the distal end (12) by a weld (120) that fixes the distal end of the lying-down and rolled folds against the exterior wall of said traction socket.

9. The expandable bone implant according to claim 1, wherein said sheet is compressed around the sleeve of the proximal end (11) and/or around the socket of the distal end (12) by a compression ring (121) that holds the lying-down and rolled folds against the exterior wall of said sleeve and/or of said socket.

10. The expandable bone implant according to claim 1, wherein the folds are, at least in the folded configuration, parallel to the longitudinal axis (L).

11. The expandable bone implant according to claim 1, wherein the sheet also comprises at least one pair of folds (a synform fold and an antiform fold) of axis not parallel to the longitudinal axis (L), preferably perpendicular so that the implant can expand also lengthwise, or oblique so that the implant can expand in a curved manner.

12. The expandable bone implant according to claim 1, wherein the number of pairs of folds is comprised between 3 and 16, generally 4 to 12, and preferably of the order of 8.

13. The expandable bone implant according to claim 1, wherein the sheet (10) has a thickness comprised between 3 and 100 microns, generally between 6 and 50, and preferably 10 and 30 microns.

14. The expandable bone implant according to claim 1, wherein the sheet (10) is made of titanium alloy.

15. The expandable bone implant according to claim 1, wherein the distance between the folds is variable for one lateral face of the implant to the other, so that the shape of the implant in the deployed configuration is curved and/or asymmetric transversely to the longitudinal axis (L).

16. System for orthopaedic treatment of damaged bone tissue, comprising at least one implant (1), a bone substitute cement and at least one instrument (A) for implantation and for injection (Ac) of cement into the implant (1), characterized in that it comprises an implant (1) according to claim 1.

17. System according to claim 16, wherein the instrument for implantation and for injection of cement comprises means for controlling the pressure and/or the aspiration of the cement so that the implant can be re-folded to the folded configuration if necessary.

18. System according to claim 16, wherein the implantation instrument is distinct from but complements the injection instrument the cement-injection canal of which passes through a canal inside the rod of the implantation instrument that via its distal end holds the proximal end of the implant.

19. Method for manufacturing an implant according to claim 1, wherein the method comprises:
Obtaining an expandable implant with two flanges that can be parted under the effect of the ends of the implant being moved closer together by support arms that connect these ends to the flanges;
Closing the sheet on itself and welding it to form a generalized cylinder;
Inserting the closed sheet on a die in the shape of a generalized cylinder having a star-shaped base and referred to as a star-shaped rod (TE), the number of branches of the star defining the number of pairs of folds of said sheet of said implant;
Compressing the closed-up sheet between said die and a plurality of projecting elements of a shape that complements the hollows between the branches of the star,
Rolling the folds of said sheet around the longitudinal axis,
Inserting said expandable implant inside said compressed sheet;
Securing said sheet to the socket and the sleeve.
